(19) United States
(12) Patent Application Publication
(10) Pub. No.: US 2008/0089411 A1
(43) Pub. Date: Apr. 17, 2008

(54) MULTIPLE-HYPOTHESIS CROSS-LAYER PREDICTION

(75) Inventors: Stephan Wenger, Hillsborough, CA (US); Ye-Kui Wang, Tampere (FI); Miska M. Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/872,636

(22) Filed: Oct. 15, 2007

Related U.S. Application Data
(60) Provisional application No. 60/852,222, filed on Oct. 16, 2006.

(51) Int. Cl. H04N 7/32

(52) U.S. Cl. 375/240.12; 375/E07.243

(57) ABSTRACT

A system and method for predicting an inter-layer predicted slice of image data from at least two different reference layers, where the inter-layer predicted slice of image data itself resides on yet another layer, different from either of the two reference layers. At least one coded block from the inter-layer predicted slice of image data is encoded with an indication, indicating to a decoder that the at least one coded block is to be inter-layer multi-predicted from the at least two different reference layers. Identifications and corresponding prediction weights of the at least two different reference layers are also signaled to the decoder either in the coded block itself, or in the inter-layer predicted slice of image data.

### FIELD OF THE INVENTION

The present invention relates generally to scalable video encoding and decoding. More specifically, the present invention relates to performing cross-layer or inter-layer prediction within a coded slice from more than one lower layer.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

There are a number of video coding standards including ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 or ISO/IEC MPEG-4 AVC. H.264/AVC is the work output of a Joint Video Team (JVT) of ITU-T Video Coding Experts Group (VCEG) and ISO/IEC MPEG. There are also proprietary solutions for video coding (e.g. VC-1, also known as SMPTE standard 421M, based on Microsoft's Windows Media Video version 9), as well as national standardization initiatives, for example AVS codec by Audio and Video Coding Standard Workgroup in China. Some of these standards already specify a scalable extension, e.g. MPEG-2 visual and MPEG-4 visual. For H.264/AVC, the scalable video coding extension SVC, sometimes also referred to as SVC standard, is currently under development.

The latest draft of the SVC is described in JVT-T201, “Joint Draft 7 of SVC Amendment,” 20th JVT Meeting, Klagenfurt, Austria, July 2006, available from http://ftp3.itu.ch/av-arch/jvt-site/2006_{—}07_Klagenfurt/JVT-T201.zip.

In SVC, a video sequence can be coded in multiple layers and each layer together with the required lower layers is one representation of the video sequence at a certain spatial resolution or temporal resolution or at a certain quality level or some combination of the three. A portion of a scalable video bitstream can be extracted and decoded at a desired spatial resolution or temporal resolution or a certain quality level or some combination of the three. A scalable video bitstream contains a non-scalable base layer and one or more enhancement layers. An enhancement layer may enhance the temporal resolution (i.e., the frame rate), the spatial resolution, or simply the quality of the video content represented by a lower layer or part thereof. In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). The concept of FGS was first introduced to standards in MPEG-4 Visual and is also part of SVC. In contrast to FGS, coarse-grained scalability (CGS) refers to the more traditional scalability concept known from MPEG-2 Video, MPEG-4 Visual/ISO-IEC 14496 Part 2, and H.263 Annex O, wherein the truncation of bitstream is not possible at any arbitrary position in the encoded bitstream but at certain positions delimiting the layers. In the existing standards, base layer information is neither FGS nor CGS scalable, but could in theory be designed to be FGS scalable as well. However, no current video compression standard or draft video compression standard implements this concept.

SVC uses the same mechanism as Advanced Video Coding (AVC) to provide temporal scalability. One important such mechanism is referred to as the “hierarchical B pictures” coding structure. In AVC, signaling of temporal scalability information can be performed by using sub-sequence-related supplemental enhancement information (SEI) messages.

SVC uses an inter-layer prediction mechanism, wherein certain information can be predicted from layers other than the currently reconstructed layer or the next layer.

Information that could be inter-layer predicted includes intra texture, motion and residual data. Inter-layer motion prediction includes the prediction of block coding mode, header information, etc., wherein motion information from a lower layer may be used for prediction of a higher layer. In the case of intra coding, a prediction from surrounding macroblocks or from co-located macroblocks of other layers is possible. These prediction techniques do not employ motion information and hence, are referred to as intra prediction techniques. Furthermore, residual data from lower layers can be employed for an efficient coding of the current layer.

SVC includes a concept known as Single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra prediction. In single-loop decoding, the decoder needs to perform motion compensation and full picture reconstruction only for the scalable layer desired for playback (called the desired layer), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

When compared to older video compression standards, SVC's spatial scalability has been generalized to enable the base layer to be a cropped and zoomed version of the enhancement layer. The quantization and entropy coding modules have also been adjusted to provide FGS capability. The coding mode is referred to as progressive refinement, where successive refinements of the transform coefficients are encoded by repeatedly decreasing the quantization step size and applying a “cyclical” entropy coding akin to sub-bitplane coding.

The scalable layer structure in the current SVC draft is characterized by three variables. These variables are temporal_level, dependency_id and quality_level. The temporal_level variable is used to indicate the temporal scalability or frame rate. A layer comprising pictures of a smaller temporal_level value has a smaller frame rate than a layer comprising pictures of a larger temporal_level. The dependency_id variable is used to indicate the inter-layer coding dependency hierarchy. At any temporal location, a picture of a smaller dependency_id value may be used for inter-layer prediction for coding of a picture with a larger dependency_id value. The quality_level variable is used to indicate FGS layer hierarchy. At any temporal location, and with an identical dependency_id value, an FGS picture with a quality_level value equal to QL uses the FGS picture or base quality picture (i.e., the non-FGS picture when QL-1=0) with a quality_level value equal to QL-1 for inter-layer prediction.

One design goal of SVC is to maintain backward compatibility with H.264/AVC, i.e., the base layer should be compliant with AVC. To realize this goal, two previously reserved network abstraction layer (NAL) unit types are used in SVC for the coded slices in enhancement layers. The three variables temporal_level, dependency_id and quality_level, among other information (including simple_priority_id and discardable_flag), are signaled in the bitstream for the enhancement layers. The simple_priority_id information indicates a priority of the NAL unit, and the discardable_flag information indicates whether the NAL unit is used for inter-layer prediction by any layer with a higher dependency_id value.

In SVC, each coded slice of a coded picture in a spatial or CGS enhancement layer has an indication (i.e., the base_id_plus1 syntax element in the slice header) of the source layer for inter-layer prediction. In a scalable video bitstream, an enhancement layer picture may freely select any lower layer for inter-layer prediction. For example, referring to FIG. 1, it is helpful to consider three layers, each having a picture therein: picture 100 in base_layer_0; picture 101 in CGS_layer_1; and picture 102 in spatial_layer_2, all having the same frame rate. A typical inter-layer prediction dependency hierarchy is shown in FIG. 1, where the arrow indicates that the pointed-to object, e.g., picture 102 in spatial_layer_2 uses the pointed-from object, e.g., picture 101 in CGS_layer_1 for inter-layer prediction reference. In addition, the pair of values to the right of each layer in FIGS. 1, 2, and 3 represent the values of dependency_id and quality_level as specified in draft SVC. However, referring to FIG. 2, a picture 202 in spatial_layer_2 may also select to use a picture 200 in base_layer_0 for inter-layer prediction as shown in FIG. 2. Furthermore, referring to FIG. 3, it is possible for a picture 302 in spatial_layer_2 to select a picture 300 in base_layer_0 to use for inter-layer prediction, while at the same temporal location, the picture 301 in CGS_layer_1 selects not to have inter-layer prediction at all, as shown in FIG. 3.

The current SVC version allows for cross-layer prediction where the prediction utilizes layers that are not necessarily the closest layers. However, prediction in the current SVC draft still utilizes only one single layer. An example of this type of prediction is shown in FIG. 2 and has been described above. Unfortunately, this arrangement causes suboptimal coding efficiency. For example, it is helpful to consider a video sequence that contains a region of interest (e.g., a performer) and a background region (e.g., the stage and background). Five layers are coded for different classes of user experiences. The base layer (layer 0) is a low quality video of the entire scene. The first enhancement layer (layer 1) corresponds to a good quality video of the region of interest (ROI). The second enhancement layer (layer 2) corresponds to a good quality video of the entire scene. The third enhancement layer (layer 3) corresponds to a high quality video of the ROI. The last enhancement layer (layer 4) corresponds to a high quality video of the entire scene. The resolution may vary among the layers. In this case, when encoding layer 2, typically the blocks in the ROI should use layer 1 for inter-layer prediction, and the blocks in the background should use layer 0 instead of layer 1 for inter-layer prediction as the background region has not been encoded in layer 1. Encoding of layer 4 is similar. One way to realize this is to encode the ROI region and the background region in different slices. However, encoding of multiple slices per picture has increased the overhead for slice headers and has lowered in-slice prediction coding efficiency.

Bi-prediction has been known in a limited form since at least MPEG-1 (ISO-IEC 11176, 1990), and from various other proposals made to the MPEG-1. The concept of generalized single-layer bi-prediction is a part of the H.264/AVC. Multiple hypothesis is yet another generalization of bi-prediction and was disclosed by Markus Flierl and Bernd Girod in their paper “Generalized B pictures and the draft H.264/AVC video-compression standard” in IEEE Transaction on Circuits and Systems for Video Technology, vol. 13, no. 7, pages 587-597, 2003.

### SUMMARY OF THE INVENTION

Various embodiments of the present invention comprise a system and method of predicting a coded inter-layer predicted slice of image data from at least two reference layers. In one embodiment of the present invention, at least one coded block signal is received from a sender, whereupon the at least one coded block signal is decoded. The decoding yields an indication that at least one coded block is inter-layer multi-predicted from the at least two reference layers, where the at least two reference layers are comprised of a first reference layer and a second reference layer. In addition, the coded inter-layer predicted slice of image data containing the at least one coded block resides in a different layer than the first and second reference layers. In another embodiment of the present invention, at least a first one of the at least one coded block is inter-layer predicted from one of the least two reference layers, and a second one of the at least one coded block is inter-layer predicted from a different one of the at least two reference layers.

The various embodiments of the present invention can be applied to inter-layer intra texture prediction, and/or inter-layer residual prediction, and/or inter-layer motion prediction. Therefore, optimal coding efficiency in scalable or layered video coding is achieved by not having to rely solely on a single layer per coded inter-layer predicted slice of image data for prediction purposes. It should also be noted that although SVC can be utilized as an example for a base scalable technology, the various embodiments of the present invention are not limited for use within the SVC framework, and can be applied equally well to other technologies.

These and other features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a conventional inter-layer prediction dependency hierarchy;

FIG. 2 shows a cross-layer prediction dependency hierarchy;

FIG. 3 shows a variation of a cross-layer prediction dependency hierarchy where a second layer selects not to utilize inter-layer prediction;

FIG. 4 shows a cross-layer/inter-layer prediction dependency hierarchy for a coded slice from more than a single lower layer utilized by one embodiment of the present invention;

FIG. 5 shows a cross-layer/inter-layer prediction dependency hierarchy for a coded slice from more than a single lower layer utilized by another embodiment of the present invention;

FIG. 6 is an overview diagram of a system within which the present invention may be implemented;

FIG. 7 is a perspective view of a mobile device that can be used in the implementation of the present invention; and

FIG. 8 is a schematic representation of the circuitry of the mobile device of FIG. 7.

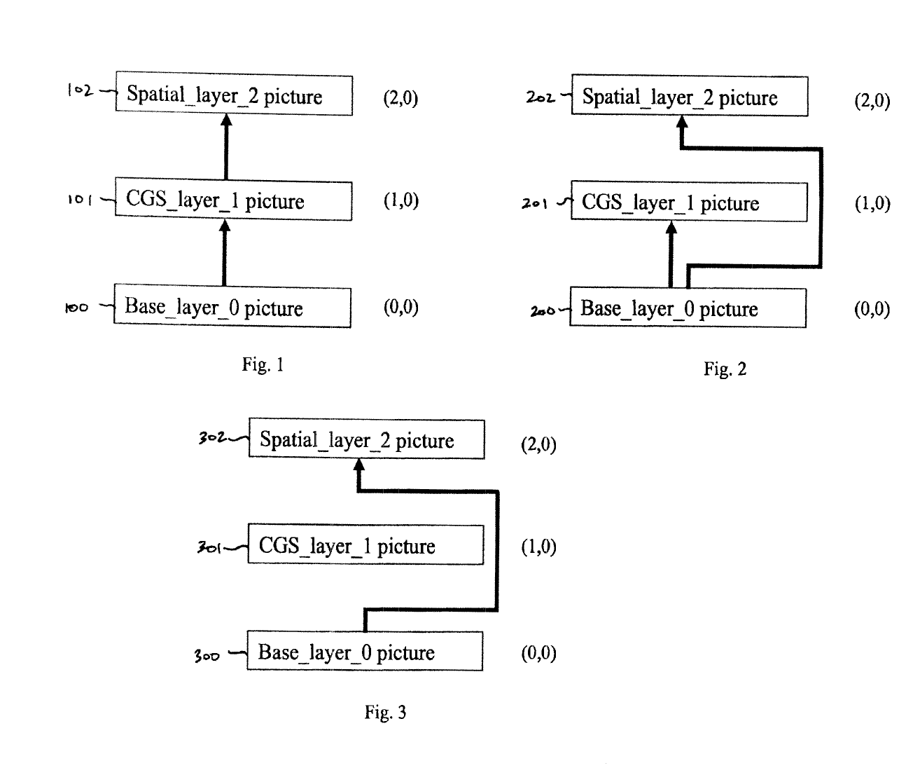

### DETAILED DESCRIPTION OF THE VARIOUS EMBODIMENTS

Various embodiments of the present invention provide a system and method, in a layered or scalable coding environment, of performing cross-layer or inter-layer prediction for a coded slice from more than one lower layer. These various embodiments can be applied to achieve optimal coding efficiency in scalable or layered video coding. It should be noted that the term “slice” refers to a certain sequence of macroblocks, where the term “macroblock” refers to a plurality of blocks, each block comprising a unit representative of how a single frame may be divided.

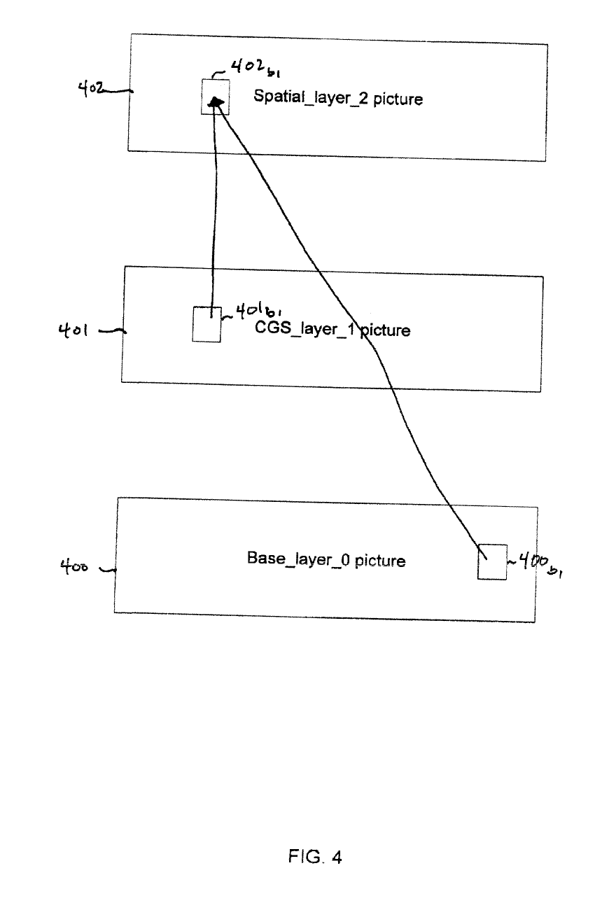

In one embodiment of the present invention, depicted in FIG. 4, each coded block is inter-layer predicted by utilizing corresponding blocks in more than a single lower layer, where each block located in a lower layer is associated with a prediction weight. For example, block 402_{b1} of picture 402 in spatial_layer_2 utilizes block 401_{b1} of picture 401 in CGS_layer_1 and block 400_{b1} of picture 400 in Base_layer_0. This particular embodiment is applicable to either inter-layer intra texture prediction or inter-layer residual prediction, but not to inter-layer motion prediction. Therefore, a receiver, receiving a coded block signal from a sender supports the decoding of coded blocks, e.g., block 402_{b1}, where the decoding results in an indication informing the receiver to utilize at least two reference layers, e.g., CGS_layer_1 and Base_layer_0, to predict block 402_{b1}. In addition, one or more new slice type values for the scalable enhancement layer slices are used to indicate that the slice contains at least one block that is inter-layer predicted from more than one lower layers. Alternatively, a flag is added to the slice header of a bit string signal for the same indication. The inter-layer predictions from more than one lower layer would then be weighted and summed to provide a final prediction signal for the present block. The identifications and the corresponding prediction weights of the lower layers used for inter-layer prediction can be encoded and signalled in the slice header as well. Each of the inter-layer predictions for the coded block would be multiplied by the corresponding weight and the final prediction would be obtained by summing the weighted predictions.

Furthermore, a new macroblock or block type is used to indicate that the block is inter-layer predicted from more than one lower layers. In the macroblock or block header of that type, the identifications and the corresponding prediction weights of the lower layers used for inter-layer prediction are encoded and signalled if they are different from the ones signalled in the slice header. One or more new profiles supporting such slices can also be defined, where the profile identification is included in the sequence parameter set. Therefore, when a sender is offering a scalable video stream to one or more receivers, it can signal whether the stream contains such slices through an indication in the bitstream (e.g., the picture parameter set) or other out of band conveyances (e.g., session description protocol information).

As used herein, the term “enhancement layer” refers to a layer that is coded differentially compared to a lower quality reconstruction. The purpose of the enhancement layer is that, when added to the lower quality reconstruction, the signal quality should improve, or be “enhanced.” Further, the term “base layer” applies to both a non-scalable base layer encoded using an existing video coding algorithm, and to a reconstructed enhancement layer relative to which a subsequent enhancement layer is coded.

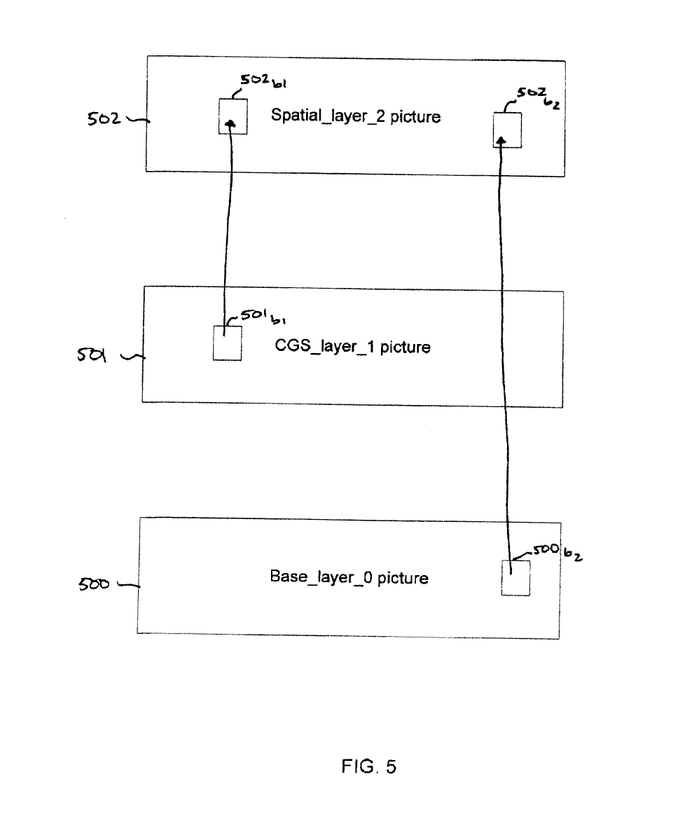

In another embodiment of the present invention, different blocks in a coded slice are predicted from different lower layers, but each block itself is predicted from a single lower layer. For example, FIG. 5 shows block 502_{b1} of picture 502 in Spatial_layer_2 utilizing block 501_{b1} of picture 501 in CGS_layer_1 for prediction, while block 502_{b2} of picture 502 in Spatial_layer_2 utilizes block 500_{b2} of picture 500 in Base_layer_0 for prediction. This aspect can be applied to any type of inter-layer prediction in the present invention, whether it be intra-texture, residual, or motion prediction. To implement this particular embodiment of the present invention, in the macroblock or block header, the identification of the lower layer used for inter-layer prediction of the block is encoded and signalled if it is different from the layer signalled in the slice header.

One example syntax change for this embodiment of the present invention based on the latest SVC draft is as follows. A first flag is added to sequence parameter set to indicate whether there is a second flag in the slice header. If present, the second flag in the slice header indicates whether in each macroblock there is information signaled to indicate which base layer is used for inter-layer prediction of that macroblock. If indicated by the second flag, an information of which base layer is used for inter-layer prediction of a macroblock is signaled for the macroblock. The information of which base layer is used for inter-layer prediction may be signaled through the dependency_id value of the inter-layer reference picture, or a difference between the dependency_id value and a prediction of the dependency_id value. For example, if the signaled value is equal to 0, the same base layer as indicated by base_id_plus1 in the slice header is used. Otherwise, the dependency_id of the base layer is equal to the sum of the signaled value and the dependency_id value derived from base_id_plus1 in the slice header.

### For example, the syntax and semantics changes compared to SVC can be as follows.

Sequence parameter set SVC extension syntax

| seq_parameter_set_svc_extension( ) { | C | Descriptor |
|---|---|---|
| extended_spatial_scalability | 0 | u(2) |
| if ( chroma_format_idc > 0 ) { | | |
| chroma_phase_x_plus1 | 0 | u(2) |
| chroma_phase_y_plus1 | 0 | u(2) |
| } | | |
| if( extended_spatial_scalability == 1 ) { | | |
| scaled_base_left_offset | 0 | se(v) |
| scaled_base_top_offset | 0 | se(v) |
| scaled_base_right_offset | 0 | se(v) |
| scaled_base_bottom_offset | 0 | se(v) |
| } | | |
| adaptive_base_flag | 2 | u(1) |
| fgs_coding_mode | 2 | u(1) |
| if( fgs_coding_mode == 1 ) { | | |
| groupingSizeMinus1 | 2 | ue(v) |
| } | | |
| if( fgs_coding_mode == 2 ) { | | |
| numPosVector = 0 | | |
| do { | | |
| if( numPosVector == 0 ) { | | |
| scanIndex0 | 2 | ue(v) |
| } | | |
| else { | | |
| deltaScanIndexMinus1[numPosVector] | 2 | ue(v) |
| } | | |
| numPosVector ++ | | |
| } while( scanPosVectLuma[ numPosVector − | | |
| 1 ] < 15 ) | | |
| } | | |
| } | | |

adaptive_base_flag equal to 1 indicates that the syntax element adaptive_base_slice_flag is present in the slice header in scalable extension. The value 0 indicates that the syntax element adaptive_base_slice_flag is not present in the slice header in scalable extension.

Slice header in scalable extension

| slice_header_in_scalable_extension( ) { | C | Descriptor |
|---|---|---|
| ... | | |
| base_id_plus1 | 2 | ue(v) |
| if( base_id_plus1 != 0 ) { | | |
| adaptive_prediction_flag | 2 | u(1) |
| if( adaptive_base_flag != 0 ) | | |
| adaptive_base_slice_flag | 2 | u(1) |
| } | | |
| ... | | |
| } | | |

adaptive_base_slice_flag equal to 1 indicates that the syntax element base_id_idc is present in the macroblock layer. The value 0 indicates that the syntax element base_id_idc is not present in the macroblock layer. When not present, the value of adaptive_base_slice_flag is inferred to be equal to 0.

Macroblock layer in scalable extension syntax

| macroblock_layer_in_scalable_extension( ) { | C | Descriptor |
|---|---|---|
| if( in_crop_window( CurrMbAddr ) ) | | |
| if(adaptive_prediction_flag ) { | | |
| base_mode_flag | 2 | u(1)\|ae(v) |
| if( ! base_mode_flag && | | |
| SpatialScalabilityType > 0 && | | |
| ! intra_base_mb( CurrMbAddr ) ) | | |
| base_mode_refinement_flag | 2 | u(1)\|ae(v) |
| } | | |
| } | | |
| if( ! base_mode_flag && | | |
| ! base_mode_refinement_flag ) { | | |
| mb_type | 2 | ue(v)\|ae(v) |
| if( mb_type == I_NxN && | | |
| in_crop_window( CurrMbAddr ) && | | |
| intra_base_mb( CurrMbAddr ) ) | | |
| intra_base_flag | 2 | u(1)\|ae(v) |
| } | | |
| if(adaptive_base_slice_flag) | | |
| base_id_idc | 2 | se(v) |
| ... | | |
| } | | |

base_id_idc indicates the base layer used for inter-prediction of the current macroblock. The dependency_id of the base layer is equal to (d_id_slice−base_id_idc), where d_id_slice is equal to the dependency_id value derived from the base_id_plus1 in the slice header, while the quality_level and fragment_order are identical to those derived from the base_id_plus1 in the slice header.
Here is a common use case. Assume that there is a CIF sequence to be served to three receivers. Two receives can display up to QCIF, one wants to view the entire picture area while the second receiver wants a region-of-interest (ROI) with better quality. The third receiver can display CIF and is connected with a good bandwidth. Therefore, three layers can be encoded to meet the requirements, with one CIF layer on the top and two QCIF layers with one being the base layer. According to SVC, the CIF layer (layer 2) can be inter-layer predicted from either the QCIF base layer (layer 0) or the QCIF enhancement layer representing only the ROI (layer 2) but not both. The following figure depicts an example of one access unit of the three layers.

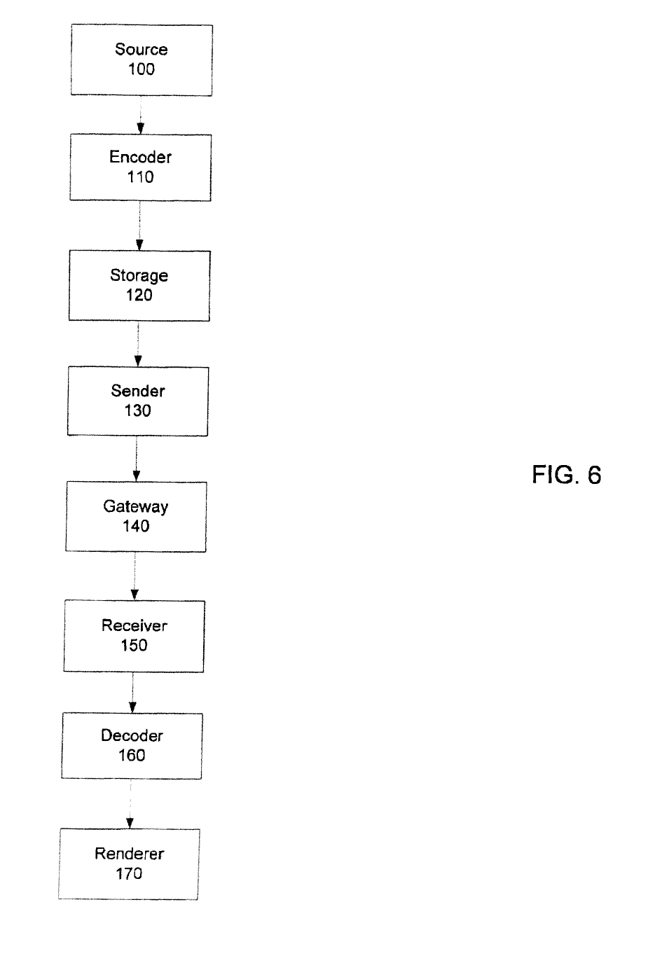

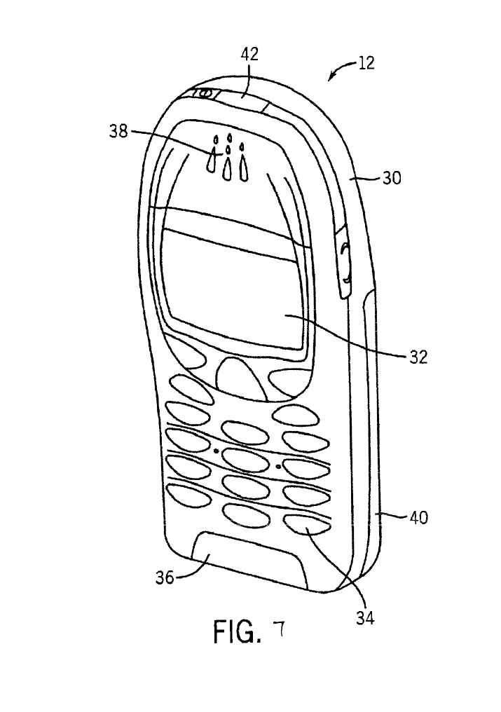

FIG. 6 shows a generic multimedia communications system for use with the present invention. As shown in FIG. 6, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The coded media bitstream is typically processed further by a decoder 160, whose output is one or more uncompressed media streams. It should be noted that the bitstream to be decoded can be received from a remote device located within virtually any type of network. Additionally, the bitstream can be received from local hardware or software. Finally, a renderer 170 may reproduce the uncompressed media streams with a loudspeaker or a display, for example. The receiver 150, decoder 160, and renderer 170 may reside in the same physical device or they may be included in separate devices.

It should be understood that, although text and examples contained herein may specifically describe an encoding process, one skilled in the art would readily understand that the same concepts and principles also apply to the corresponding decoding process and vice versa.

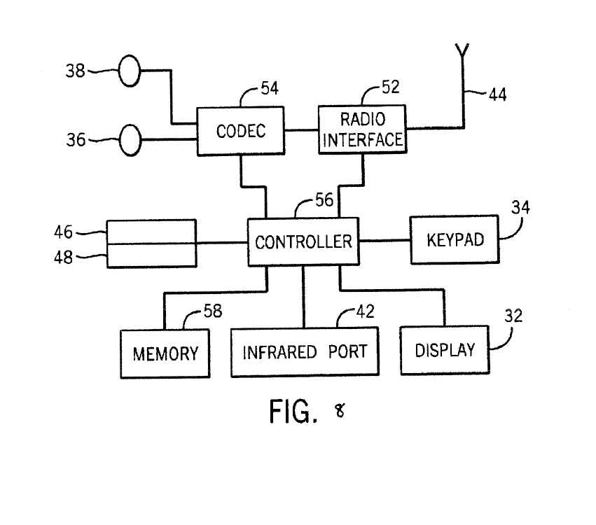

FIGS. 7 and 8 show an example implementation as part of a communication device (such as a mobile communication device like a cellular telephone, or a network device like a base station, router, repeater, etc.). However, it is important to note that the present invention is not limited to any type of electronic device and could be incorporated into devices such as personal digital assistants, personal computers, mobile telephones, and other devices. It should be understood that the present invention could be incorporated on a wide variety of devices.

The device 12 of FIGS. 7 and 8 includes a housing 30, a display 32, a keypad 34, a microphone 36, an ear-piece 38, a battery 40, radio interface circuitry 52, codec circuitry 54, a controller 56 and a memory 58. Individual circuits and elements are all of a type well known in the art, for example in the Nokia range of mobile telephones. The exact architecture of device 12 is not important. Different and additional components of device 12 may be incorporated into the device 12. The scalable video encoding and decoding techniques of the present invention could be performed in the controller 56 memory 58 of the device 12.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

Software and web implementations could be accomplished with standard programming techniques with rule based logic and other logic to accomplish the various database searching steps, correlation steps, comparison steps and decision steps. It should also be noted that the words “module” as used herein and in the claims is intended to encompass implementations using one or more lines of software code, and/or hardware implementations, and/or equipment for receiving manual inputs.

What is claimed is:

1. A method of inter-layer prediction for use in scalable video coding, wherein a coded inter-layer predicted slice of image data is predicted from at least a first reference layer and a second reference layer, and wherein the at least first reference layer is different from the at least second reference layer, comprising:
receiving at least one coded block signal;
decoding the at least one coded block signal; the decoding yielding an indication that at least one coded block is inter-layer predicted from at least the first reference layer and the second reference layer, and wherein the coded inter-layer predicted slice of image data containing the at least one coded block resides in a different layer than the first and second reference layers;
forming a first inter-layer prediction corresponding to the first reference layer and at least a second inter-layer prediction corresponding to the second reference layer; and
calculating a weighted sum of the first inter-layer prediction and the second inter-layer prediction, using a first prediction weight parameter for the first inter-layer prediction and a second prediction weight parameter for the second inter-layer prediction, to provide a prediction for the coded block signal.

2. The method of claim 1, wherein the coded inter-layer predicted slice of image data comprises a signal identifying at least the first and second reference layers.

3. The method of claim 2, wherein the coded inter-layer predicted slice of image data comprises a signal indicating the first prediction weight and the second prediction weight.

4. The method of claim 1, wherein the coded block comprises a signal identifying at least the first and second reference layers.

5. The method of claim 1, wherein the coded block comprises a signal indicating the first prediction weight and the second prediction weight.

6. A method of encoding at least one coded block signal for inter-layer prediction, wherein a coded inter-layer predicted slice of image data is predicted from at least a first reference layer and a second reference layer in a scalable video coding scheme, and wherein the at least first reference layer is different from the at least second reference layer, the method comprising:
encoding the at least one coded block signal with an indication that at least one coded block is inter-layer predicted from at least the first and second reference layers, and wherein the coded inter-layer predicted slice of image data containing the at least one coded block resides in a different layer than the first and second reference layers.

7. The method of claim 6, wherein the coded inter-layer predicted slice of image data comprises a signal identifying at least the first and second reference layers.

8. The method of claim 7, wherein the coded inter-layer predicted slice of image data comprises a signal indicating a first prediction weight and a second prediction weight.

9. The method of claim 6, wherein the coded block comprises a signal identifying at least the first and second reference layers.

10. The method of claim 6, wherein the coded block comprises a signal indicating a first prediction weight and a second prediction weight.

11. An apparatus comprising:
a processor; and
a memory unit operatively connected to the processor and including a computer program product for inter-layer prediction for use in scalable video coding, wherein a coded inter-layer predicted slice of image data is predicted from at least a first reference layer and a second reference layer, and wherein the at least first reference layer is different from the at least second reference layer, comprising:
computer code for receiving at least one coded block signal;
computer code for decoding the at least one coded block signal; the decoding yielding an indication that at least one coded block is inter-layer multi-predicted from at least the first and second reference layers, and wherein the coded inter-layer predicted slice of image data containing the at least one coded block resides in a different layer than the first and second reference layers;
computer code for forming a first inter-layer prediction corresponding to the first reference layer and at least a second inter-layer prediction corresponding to the second reference layer; and
computer code for calculating a weighted sum of the first inter-layer prediction and the second inter-layer prediction, using a first prediction weight parameter for the first inter-layer prediction and a second prediction weight parameter for the second inter-layer prediction, to provide a prediction for the coded block signal.

12. The apparatus of claim 11, wherein the coded inter-layer predicted slice of image data comprises a signal identifying at least the first and second reference layers.

13. The apparatus of claim 12, wherein the coded inter-layer predicted slice of image data comprises a signal indicating the first prediction weight and the second prediction weight.

14. The apparatus of claim 11, wherein the coded block comprises a signal identifying at least the first and second reference layer.

15. The apparatus of claim 11, wherein the coded block comprises a signal indicating the first prediction weight and the second prediction weight.

16. A computer program product, embodied on a computer-readable medium, for inter-layer prediction for use in scalable video coding, wherein a coded inter-layer predicted slice of image data is predicted from at least a first reference layer and a second reference layer, and wherein the at least first reference layer is different from the at least second reference layer, comprising:
computer code for receiving at least one coded block signal;
computer code for decoding the at least one coded block signal; the decoding yielding an indication that at least one coded block is inter-layer predicted from at least the first reference layer and the second reference layer, and wherein the coded inter-layer predicted slice of image data containing the at least one coded block resides in a different layer than the first and second reference layers;
computer code for forming a first inter-layer prediction corresponding to the first reference layer and at least a second inter-layer prediction corresponding to the second reference layer; and
computer code for calculating a weighted sum of the first inter-layer prediction and the second inter-layer prediction, using a first prediction weight parameter for the first inter-layer prediction and a second prediction weight parameter for the second inter-layer prediction, to provide a prediction for the coded block signal.

17. A computer program product, embodied on a computer-readable medium, for inter-layer prediction, wherein a coded inter-layer predicted slice of image data is predicted from at least a first reference layer and a second reference layer in a scalable video coding scheme, and wherein the at least first reference layer is different from the at least second reference layer, comprising:
computer code for encoding the at least one coded block signal with an indication that at least one coded block is inter-layer multi-predicted from at least the first and second reference layers, and wherein the coded inter-layer predicted slice of image data containing the at least one coded block resides in a different layer than the first and second reference layers.
